(19) United States
(12) Patent Application Publication
(10) Pub. No.: US 2011/0158559 A1
(43) Pub. Date: Jun. 30, 2011

(54) SIDE STRAP HANDLE BAG

(75) Inventors: Lawrence B. Nicolais, Elkins Park, PA (US); Francis Bruneau, Drummondville (CA)

(73) Assignee: SCA HYGIENE PRODUCTS AB, Goteborg (SE)

(21) Appl. No.: 12/648,371

(22) Filed: Dec. 29, 2009

(51) Int. Cl. B65D 33/06; B65D 30/20; B31B 1/86; B31B 1/26; B31B 47/04

(52) U.S. Cl. 383/12; 383/120; 493/226; 493/243; 493/267

(57) ABSTRACT

A bottom gusset bag includes a gusset connecting a front and rear panel. The side regions of the front and rear panels are sealed to each other in a pair of side seams in a manner such that when the bag is unfilled it is flattened and when the bag is filled it is substantially a six-sided cubic shape with the bottom of the filled bag formed of the bottom gusset being substantially flat. The bottom gusset bag further includes a side handle that includes a strip of material exterior of the gusset with the ends of the handle joined to each pair of side seams. The handle extends along an exterior surface of the bag from a first side seam along an exterior surface of the rear or front panel to a second side seam.

### FIELD OF THE INVENTION

The present disclosure relates to a bottom gusset bag having a strap handle on the side. More particularly, the present disclosure relates to a bottom gusset bag having a strap handle that extends around the rear or front surface of the bag.

### BACKGROUND OF THE INVENTION

Bottom gusset bags are typically used to contain goods, where the goods act as the support to hold the bags in a particular shape. For convenience of transporting the filled bottom gusset bags, handles have been added to the bags. When filled with product and sealed, the bottom gusset is used as the bags upward facing surface because it is usually more aesthetically pleasing. This also provides a place to add handles that do not interfere with the loading and final sealing of a bag at the open end of the bag. Completed, sealed bags are generally “cubic” or hexahedral in configuration when filled with goods such as disposable diapers or adult disposable briefs.

There are several ways to make external handles or to attach a handle to a preformed bottom gusset bag. Some of the methods add significant cost to the bag because a relatively large amount of plastic film is added to the bag forming a handle. These methods generally make strong handles that function well, but are costly.

Some methods keep material costs low by forming a handle from part of the existing bag without adding extra material. However, these handles can be weak and may not be suitable for heavier or larger bags.

Another method is the attachment of a plastic film strap to the surface that is upward facing when the bag is carried. This bag style is commonly called a bottom gusset strap handle bag or bottom gusset bag with strap handle. When filled with product and sealed, the bag may be turned upside down, presenting the bottom gusset panel as the top containing the strap for carrying. This method is typically a compromise in material cost and strength between the previously mentioned ideas. Although the strap can be designed to function well as a handle for various weights and sizes of bags, the strap is not aesthetically pleasing. Specifically, the strap is typically loose on the gusset panel of the filled bag, which is exposed during display at retail outlets.

Further, the exterior plastic film strap has a negative impact on the automated packaging process because the strap can become entangled in the packaging machinery. An entangled exterior plastic film strap can lead to the destruction of the handle or bag, or can jam the conveyor system leading to downtime in the automatic packing process. Further, strap handle bags are typically shipped in shipping boxes, and an exterior plastic film strap can interfere with packing the bags into the shipping box or get caught in the taped or glued seal of the shipping box, rendering the handle or bag damaged or useless when the box is opened and bags withdrawn.

Accordingly, there is a need in the art for a bottom gusset bag with handle that is easy to manufacture using existing bag making machines, inexpensive, effective and easy to use by the consumer, aesthetically pleasing to display, and does not cause packaging line problems.

### SUMMARY

According to a first aspect of the invention, a bottom gusset bag includes a gusset connecting a front panel having an upper edge, lower edge, and two side regions and a rear panel having an upper edge, lower edge, and two side regions. The gusset joins the front and rear panels at the lower edges. The side regions of the front and rear panels are sealed to each other in a pair of side seams in a manner such that when the bag is unfilled it is flattened and when the bag is filled it is substantially a six-sided cubic shape with front, rear, top, bottom, and two side walls. The bottom is formed of the bottom gusset being substantially flat. The bag further includes a handle. The handle includes a strip of material extending from a first side seam along the exterior surface of the front or rear panel to a second side seam.

According to a second aspect of the invention, a method of manufacturing a bag includes folding a material laterally on itself to form front and rear panels and a bottom gusset between the front and rear panels at the bottom of the bag. Sealing side regions of the front and rear panels to form side seams. Sealing a handle to an exterior surface of the bag. The handle extends along an exterior surface of the bag from a first side seam along an exterior surface of the rear or front panel to a second side seam.

A further feature of the first and second aspects is that ends of the handle are joined to an exterior surface of the bag at the side seams.

Yet a further feature of the first and second aspects is that the handle is joined to the bag only at the ends of the handle, which are heat sealed to the bag at the side seams.

Still yet a further feature of the first and second aspects is that the bag and handle are formed of heat sealable plastic films or heat sealable non-woven materials.

Still yet a further feature of the first and second aspects is that the handle and the material forming the bag are formed of the same materials.

Still yet a further feature of the first and second aspects is that the handle and the material forming the bag are formed of different materials.

Still yet a further feature of the first and second aspects is that the bag further includes an angle fold folding a front side of an end of the gusset to the front panel and another angle fold folding a rear side of the same end of the gusset to the rear panel, wherein the angle folds extend from a lower edge of the front or rear panel to a common point at the side seam.

Still yet a further feature of the first and second aspects is that an end of the handle is joined to an exterior surface of the side region at a position between the lower edge and half the depth of the gusset where the angle folds meet at the common point at the side seam of the bag.

Still yet a further feature of the first and second aspects is that an end of the handle is joined to an exterior surface of the side region so that one edge of the end of the handle is at the common point formed by the angle folds, and an opposing edge of the end of the handle is closer to the lower edge.

Still yet a further feature of the first and second aspects is that an end of the handle is joined to an exterior surface of the side region closer to the lower edge than the common point.

Yet still another feature of the second aspect is that the handle and side region sealing steps are performed simultaneously.

### BRIEF DESCRIPTION OF THE DRAWINGS

The accompanying drawing provides visual representations which will be used to more fully describe the representative embodiments disclosed herein and can be used by those skilled in the art to better understand them and their inherent advantages. In the drawing, like reference numerals identify corresponding elements.

FIG. 1 shows a perspective view of an exemplary embodiment of a bottom gusset bag having a side strap handle.

FIG. 2 shows a perspective view of the side strap handle bottom gusset bag of FIG. 1 where the handle is extended upward when the bag is being carried.

FIG. 3 shows a partial exploded view of a corner of the bottom gusset bag of FIG. 1.

FIG. 4 shows a partial exploded view of a corner of another exemplary embodiment of a bottom gusset bag having a side strap handle similar to the bottom gusset bag of FIG. 1.

### DETAILED DESCRIPTION OF THE PREFERRED EMBODIMENTS

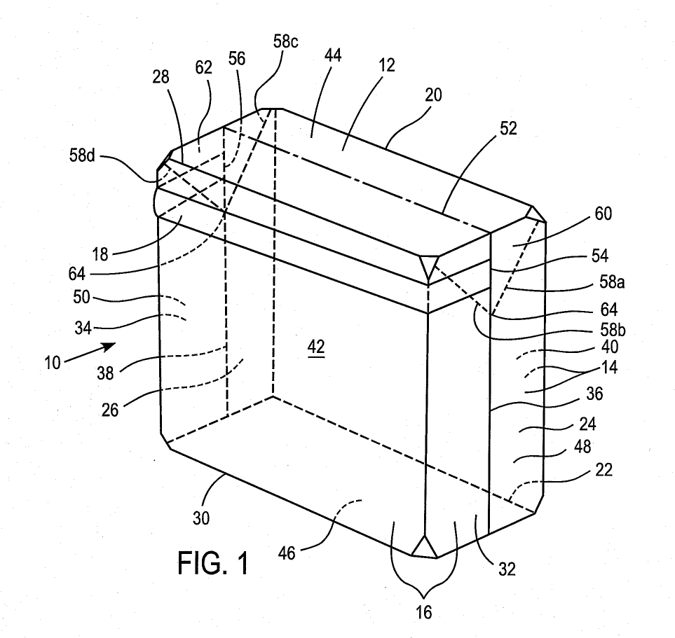

With reference to FIG. 1, a first embodiment of an absorbent article in accordance with the present invention is described in more detail. A bottom gusset bag can be made of a material that is folded and sealed to form a bag that is flattened when unfilled and maintains a particular shape based on the goods contained when the bag is filled. Goods stored in bottom gusset bags can include infant diapers and training pants and adult incontinence products. However, the bottom gusset bags can be used to store other types of goods. While the FIG. 1 specifically illustrates a filled bottom gusset bag 10 having a generally “cubic” or hexahedral configuration, the bottom gusset bag may form different shapes depending on the type of goods to be contained.

With reference in particular to FIG. 1, a bottom gusset bag 10 includes a gusset 12 connecting a front panel 14 and a rear panel 16. The front panel 14 includes a front lower edge 20, front upper edge 22, and two front side regions 24, 26. The rear panel 16 includes a rear lower edge 28, rear upper edge 30, and two rear side regions 32, 34. The bottom gusset 12 joins the front and rear panels 14, 16 at respective lower edges 20, 28. The first front side region 24 is joined to a first rear side region 32 at a first side seam 36. The second front side region 26 is joined to a second rear side region 34 at a second side seam 38.

When the bottom gusset bag 10 is unfilled, it is flattened. When the bottom gusset bag 10 is filled with goods as it is shown in FIG. 1, the bag assumes a substantially six-sided cubic shape with front 40, rear 42, bottom 44, top 46, and two side walls 48, 50. The bottom 44, which in use is the upward surface of the filled bag is formed of the bottom gusset 12 in a substantially flat state.

The bottom gusset bag 10 further includes a side handle 18. The handle can be attached to the exterior surface of the bag around the rear or front. In a first embodiment, the handle is a strip of material extending around the exterior surface of the rear or front panel. With reference in particular to FIG. 1, the handle 18 extends from the first side seam 36 along the exterior surface of the rear panel 16 or the front panel 14 to the second side seam 38. The first end 54 of the handle can be heat sealed to the first side seam 36, and the second end 56 can be heat sealed to the second side seam 38.

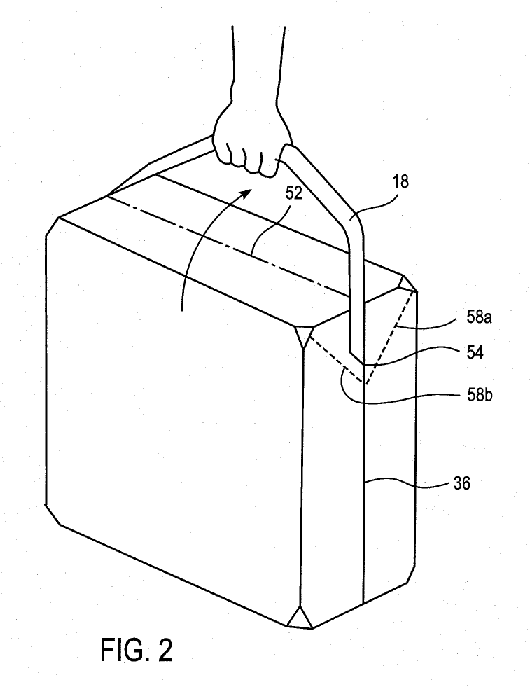

With reference in particular to FIG. 1, the handle 18 is tight and remains in direct contact with the rear panel 16 or the front panel 14 from the first side seam 36 to the second side seam 38. When the bag is lifted by the handle 18, the strap will naturally orient itself above the bag in a position similar to that illustrated in FIG. 2.

In one embodiment, ends of the handle are joined directly to the side seams. In a further embodiment, an end of the handle is joined to the pair of side regions or side seam at a position between the lower edge and the common point 64.

With reference to FIG. 1, the bottom gusset bag 10 further includes angle folds 58. In FIG. 1, first angle fold 58a joins the front side of the first end 60 of the bottom gusset to the first front side region 24, and second angle fold 58b joins the rear side of the first end 60 of the bottom gusset to the first rear side region 32. The first and second angle folds 58a, 58b each extend from respective lower edges 20, 28 of the front and rear panels to a common point 64 at the first side seam 36. In the same manner, the third angle fold 58c and fourth angle fold 58d join the front side of the second end 62 of the bottom gusset to the second front side region 26 and the rear side of the second end 62 of the bottom gusset to the second rear side region 34, respectively. When the bag is filled, the ends 60, 62 of the bottom gusset form a portion of the side walls 48, 50.

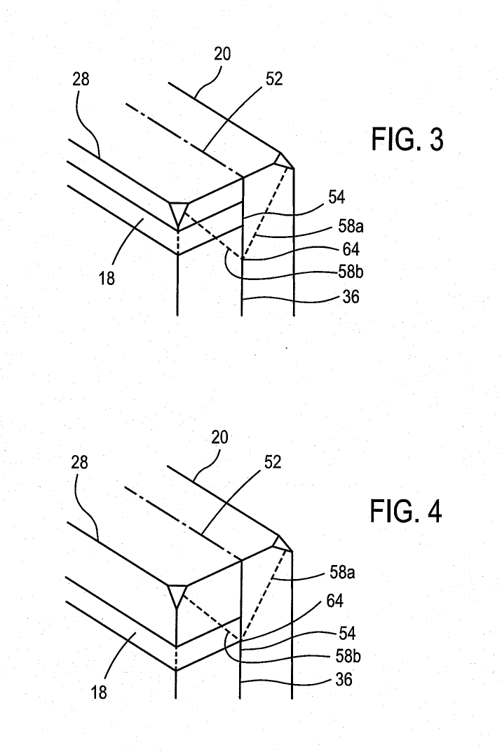

With particular reference to FIG. 1, when the bottom gusset bag 10 is filled, the angle folds 58 delimit ends of the bottom gusset material that form a portion of the side walls 48, 50. In the embodiment illustrated in FIG. 1, the ends 60, 62 of the bottom gusset are triangular with the line where the end is folded onto the side walls 48, 50 and the end folds 58 forming the three edges of the triangle. The ends of the handle can be joined to the side seams at different locations in relation to the common point formed by the angle folds. In some embodiments, with reference to FIG. 3, an end 54 of the handle is joined to the exterior surface of the side region 32, 34 closer to the lower edge 20, 28 than the common point 64. In another embodiment, with reference to FIG. 4, an end 54 of the handle can be joined to the exterior surface of the side region 32, 34 so that one edge of the end 54 of the handle is at the common point 64 formed by the angle folds, and the other edge of the end 54 of the handle is closer to the lower edge 20, 28.

In certain embodiments, the bag and handle are formed of flaccid material. A flaccid material is defined as a material that is flexible and used to cover articles that will act as a support for the material. In more certain embodiments, the bag and handle are formed of plastic films or non-woven materials. In yet more certain embodiments, plastic films and non-woven are heat sealable so that any or all of the side seams or connection of the handle to the exterior of the bag are formed by heat sealing. Exemplary heat sealable materials that can be used as plastic films or non-woven materials in formation of the bag or handle include polyethylene, polypropylene or polylactic acid. Polylactic acid has the additional advantage of being biodegradable. The bag and handle can be made from the same or different materials. Differences in materials forming the bag and handle can include, for example, differences in type of plastic, color, weight, or strength.

In certain embodiments, the handle has a width that is substantially smaller than the width of the gusset. In some embodiments, the width of the handle is less than about a third the width of the gusset. In further embodiments, the width of the handle is less than about a quarter the width of the gusset. In yet further embodiments, the width of the handle is less than about a sixth the width of the gusset.

An embodiment of a method of making the above described bottom gusset bag includes folding and sealing a material into a bottom gusset bag. In particular embodiments, the material is folded laterally on itself to form front and rear panels and a gusset panel between the front and rear panels at the bottom of the bag. Side regions of the front and rear panels are sealed to form side seams. Further, a handle can be sealed to the exterior surface of the bag. The handle can extend along an exterior surface of the bag from a first side seam along an exterior surface of the front or rear panel to a second side seam. In many embodiments, the step of sealing the ends of the handle to an exterior surface of the bag and sealing the front and rear panels at respective side seams are each accomplished by heat sealing. The handle and side region sealing steps can be performed sequentially or simultaneously.

Although the present invention has been described in connection with preferred embodiments thereof, it will be appreciated by those skilled in the art that additions, deletions, modifications, and substitutions not specifically described may be made without department from the spirit and scope of the invention as defined in the appended claims.

1. A bottom gusset bag comprising:
a gusset connecting a front panel having an upper edge, lower edge, and two side regions and a rear panel having an upper edge, lower edge, and two side regions, the gusset joins the front and rear panels at the lower edges, the side regions of the front and rear panels are sealed to each other in a pair of side seams in a manner such that when the bag is unfilled it is flattened and when the bag is filled it is substantially a six-sided cubic shape with front, rear, top, bottom, and two side walls, wherein the bottom is formed of the bottom gusset being substantially flat, and a handle for said bag, said handle comprising a strip of material extending from a first side seam along the exterior surface of the front or rear panel to a second side seam.

2. The bag of claim 1, wherein ends of the handle are joined to an exterior surface of the bag at the side seams.

3. The bag of claim 1, wherein the handle is joined to the bag only at the ends of the handle, which are heat sealed to the bag at the side seams.

4. The bag of claim 1, wherein the bag and handle are formed of heat sealable plastic films or heat sealable non-woven materials.

5. The bag of claim 1, wherein the handle and the material forming the bag are formed of the same materials.

6. The bag of claim 1, wherein the handle and the material forming the bag are formed of different materials.

7. The bag of claim 1 further comprising an angle fold folding a front side of an end of the gusset to the front panel and another angle fold folding a rear side of the same end of the gusset to the rear panel, wherein the angle folds extend from a lower edge of the front or rear panel to a common point at the side seam.

8. The bag of claim 7, wherein an end of the handle is joined to an exterior surface of the side region at a position between the lower edge and half the depth of the gusset where the angle folds meet at the common point at the side seam of the bag.

9. The bag of claim 7, wherein an end of the handle is joined to an exterior surface of the side region so that one edge of the end of the handle is at the common point formed by the angle folds, and an opposing edge of the end of the handle is closer to the lower edge.

10. The bag of claim 7, wherein an end of the handle is joined to an exterior surface of the side region closer to the lower edge than the common point.

11. A method of manufacturing a bag, comprising:
folding a material laterally on itself to form front and rear panels and a gusset panel between the front and rear panels at the bottom of the bag;
sealing side regions of the front and rear panels to form side seams; and
sealing a handle to an exterior surface of the bag,
wherein the handle extends along an exterior surface of the bag from a first side seam along an exterior surface of the front or rear panel to a second side seam.

12. The method of claim 11, wherein each end of the handle is heat sealed to the exterior surface of the bag at the side seams.

13. The method of claim 11, wherein the handle is heat sealed to the bag only at the ends of the handle.

14. The method of claim 11, wherein the bag and handle are formed of heat sealable plastic films or heat sealable non-woven materials.

15. The method of claim 11, wherein the handle and the material forming the bag are formed of the same materials.

16. The method of claim 11, wherein the handle and the material forming the bag are formed of different materials.

17. The method of claim 11 further comprising the steps of angle folding a front side of an end of the gusset to the front panel and angle folding a rear side of the same end of the gusset to the rear panel, wherein the angle folds extend from a lower edge of the front or rear panel to a common point at the side seam.

18. The bag of claim 17, wherein an end of the handle is joined to an exterior surface of the side region at a position between the lower edge and half the depth of the gusset where the angle folds meet at the common point at the side seam of the bag.

19. The method of claim 17, wherein an end of the handle is joined to an exterior surface of the side region so that one edge of the end of the handle is at the common point formed by the angle folds, and an opposing edge of the end of the handle is closer to the lower edge.

20. The bag of claim 17, wherein an end of the handle is joined to an exterior surface of the side region closer to the lower edge than the common point.

21. The method of claim 11, wherein the handle and side region sealing steps are performed simultaneously.
